(19) United States
(12) Patent Application Publication
(10) Pub. No.: US 2007/0028215 A1
(43) Pub. Date: Feb. 1, 2007

(54) Method and system for hierarchical namespace synchronization

(75) Inventors: Vinay T. Kamath, Rancho Santa Margarita, CA (US); Llewellyn J. Knox-Davies, Rancho Santa Margarita, CA (US); Douglas Kane, Silverado, CA (US); Hendrik Johannes Victor, Rancho Santa Margarita, CA (US); Dimitre K. Ivanov, Rancho Santa Margarita, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Invensys Systems, Inc., Foxboro, MA (US)

(21) Appl. No.: 11/492,552

(22) Filed: Jul. 25, 2006

Related U.S. Application Data
(60) Provisional application No. 60/702,654, filed on Jul. 26, 2005.
(60) Provisional application No. 60/704,687, filed on Aug. 2, 2005.

(51) Int. Cl. G06F 9/44

(52) U.S. Cl. 717/120

(57) ABSTRACT

Disclosed are techniques for synchronizing software objects in one namespace with software objects in another namespace. When a change is detected in the first namespace (such as the addition, deletion, or movement of a software object), only as much information as is needed to characterize the change is sent to the second namespace. The second namespace then replicates the changed status of the first namespace. In one embodiment of the invention, an Archestra namespace is synchronized with an InSQL namespace by applying the public/private namespace capability of InSQL.

### CROSS-REFERENCE TO RELATED APPLICATION

This application claims priority to U.S. Provisional Patent Applications 60/702,654, “Method and System for Hierarchical Namespace Synchronization,” filed on Jul. 26, 2005, and 60/704,687, “Method and System for Hierarchical Namespace Synchronization,” filed on Aug. 2, 2005, which are incorporated herein by reference in their entireties.

### FIELD OF THE INVENTION

The present invention generally relates to computing and networked data storage systems, and, more particularly, to techniques for managing (e.g., storing, retrieving, processing) streams of supervisory control, manufacturing, and production information. Such information is typically rendered and stored in the context of supervising automated processes.

### BACKGROUND OF THE INVENTION

Industry increasingly depends upon highly automated data acquisition and control systems to ensure that industrial processes are run efficiently and reliably while lowering the overall production costs. Data acquisition begins when a number of sensors measure aspects of an industrial process and report their measurements back to a data collection and control system. Such measurements come in a wide variety of forms. By way of example the measurements produced by sensors could include a temperature, a pressure, a pH, a mass or volume flow of material, a counter of items passing through a particular machine or process, a tallied inventory of packages waiting in a shipping line, cycle completions, and a photograph of a room in a factory. Often sophisticated process management and control software examines the incoming data associated with an industrial process, produces status reports and operation summaries, and, in many cases, responds to events and to operator instructions by sending commands to controllers that modify operation of at least a portion of the industrial process. The data produced by the sensors also allow an operator to perform a number of supervisory tasks including tailoring the process (e.g., specifying new setpoints) in response to varying external conditions (including costs of raw materials), detecting an inefficient or non-optimal operating condition or impending equipment failure, and taking remedial action such as moving equipment into and out of service as required.

A simple and familiar example of a data acquisition and control system is a thermostat-controlled home heating and air conditioning system. A thermometer measures a current temperature; the measurement is compared with a desired temperature range; and, if necessary, commands are sent to a furnace or cooling unit to achieve a desired temperature. Furthermore, a user can program or manually set the controller to have particular setpoint temperatures at certain time intervals of the day.

Typical industrial processes are substantially more complex than the above described simple thermostat example. In fact, it is not unheard of to have thousands or even tens of thousands of sensors and control elements (e.g., valve actuators) monitoring and controlling all aspects of a multi-stage process within an industrial plant. The amount of data sent for each measurement and the frequency of the measurements vary from sensor to sensor in a system. For accuracy and to facilitate quick notice and response of plant events and upset conditions, some of these sensors update and transmit their measurements several times every second. When multiplied by thousands of sensors and control elements, the volume of data generated by a plant's supervisory process control and plant information system can be very large.

Specialized process control and manufacturing and production information data storage facilities (also referred to as plant historians) have been developed to handle the potentially massive amounts of production information generated by the aforementioned systems. An example of such a system is the WONDERWARE IndustrialSQL Server historian. A data acquisition service associated with the historian collects time-series data from a variety of data sources (e.g., data access servers). The collected data are thereafter deposited with the historian to achieve data access efficiency and querying benefits and capabilities of the historian's relational database. Through its relational database, the historian integrates plant data with event, summary, production, and configuration information.

Traditionally, plant historians have collected and archived streams of time-stamped data representing process, plant, and production status over the course of time. The status data are of value for purposes of maintaining a record of plant performance and for presenting and recreating the state of a process or plant equipment at a particular point in time. However, individual pieces of data taken at single points in time are often insufficient to discern whether an industrial process is operating properly or optimally. Further processing of the time-stamped data often renders more useful information for operator decision making.

Over the years vast improvements have occurred with regard to networks, data storage and processor device capacity, and processing speeds. Notwithstanding such improvements, supervisory process control and manufacturing information system designs encounter a need to either increase system capacity and speed or to forgo saving certain types of information derived from time-stamped data because creating and maintaining the information on a full-time basis draws too heavily from available storage and processor resources. Thus, while valuable, certain types of process information are potentially not available in certain environments. Such choices can arise, for example, in large production systems where processing data to render secondary information is potentially of greatest value.

In the past, the InSQL historian stored configuration information for its tags in a SQL Server database, separate from the Archestra Galaxy Repository. Tags created in InSQL by an Industrial Application Server (IAS) to represent historical data associated with object attributes were therefore essentially part of a separate, flat namespace in InSQL that did not reflect the original object hierarchy embodied in the Archestra model view. This made it cumbersome for users accustomed to the model view in Archestra to navigate to and view data for a particular object attribute in InSQL because they had to “remember” the InSQL tagname for the attribute.

### BRIEF SUMMARY OF THE INVENTION

In view of the foregoing, the present invention provides techniques for synchronizing software objects in one namespace with software objects in another namespace. When a change is detected in the first namespace (such as the addition, deletion, or movement of a software object), only as much information as is needed to characterize the change is sent to the second namespace. The second namespace then replicates the changed status of the first namespace. In one embodiment of the invention, an Archestra namespace is synchronized with an InSQL namespace by applying the public/private namespace capability of InSQL.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an exemplary networked environment wherein a process control database server embodying the present invention is advantageously incorporated;

FIG. 2 is a schematic drawing of functional and structural aspects of a historian service embodying the present invention;

FIG. 3 is a logical sequence diagram showing how a change in Archestra is propagated to InSQL; and

FIG. 4 is a schematic diagram of a mapping between an Archestra model view and an InSQL group namespace.

### DETAILED DESCRIPTION OF THE INVENTION

As noted previously in the background, a plant information historian service maintains a database comprising a wide variety of plant status information. The plant status information, when provided to operations managers in its unprocessed form, offers limited comparative information such as how a process or the operation of plant equipment has changed over time. In many cases, performing additional analysis on data streams to render secondary information greatly enhances the information value of the data. In embodiments of the invention, such analysis is delayed until a client requests such secondary information from the historian service for a particular timeframe. As such, limited historian memory and processor resources are only allocated to the extent that a client of the historian service has requested the secondary information. In particular, the historian service supports a set of advanced data retrieval operations wherein data are processed to render particular types of secondary information “on demand” and in response to “client requests.”

The terms “client requests” and “on demand” are intended to be broadly defined. The plant historian service embodying the present invention does not distinguish between requests arising from human users and requests originating from automated processes. Thus, a “client request,” unless specifically noted, includes requests initiated by human/machine interface users and requests initiated by automated client processes. The automated client processes potentially include processes running on the same node as the historian service. The automated client processes request the secondary information and thereafter provide the received secondary information, in a service role, to others. Furthermore, the definition of “on demand” is intended to include both providing secondary information in response to specific requests as well as in accordance with a previously established subscription. By performing the calculations to render the secondary information on demand, rather than calculating (and tabling) the information without regard to whether it will ever be requested by a client, the historian system embodying the present invention is better suited to support a very broad and extensible set of secondary information types meeting diverse needs of a broad variety of historian service clients.

In an embodiment of the present invention, the historian service supports a variety of advanced retrieval operations for calculating and providing, on demand, a variety of secondary information types from data previously stored in the historian database. Among others, the historian service specifically includes the following advanced data retrieval operations: “time-in-state,” “counter,” “engineering units-based integral,” and “derivative.” “Time-in-state” calculations render statistical information relating to an amount of time spent in specified states. Such states are represented, for example, by identified tag/value combinations. By way of example, the time-in-state statistics include, for a specified time span and tagged state value: total amount of time in the state, percentage of time in the state, the shortest time in the state, and the longest time in the state.

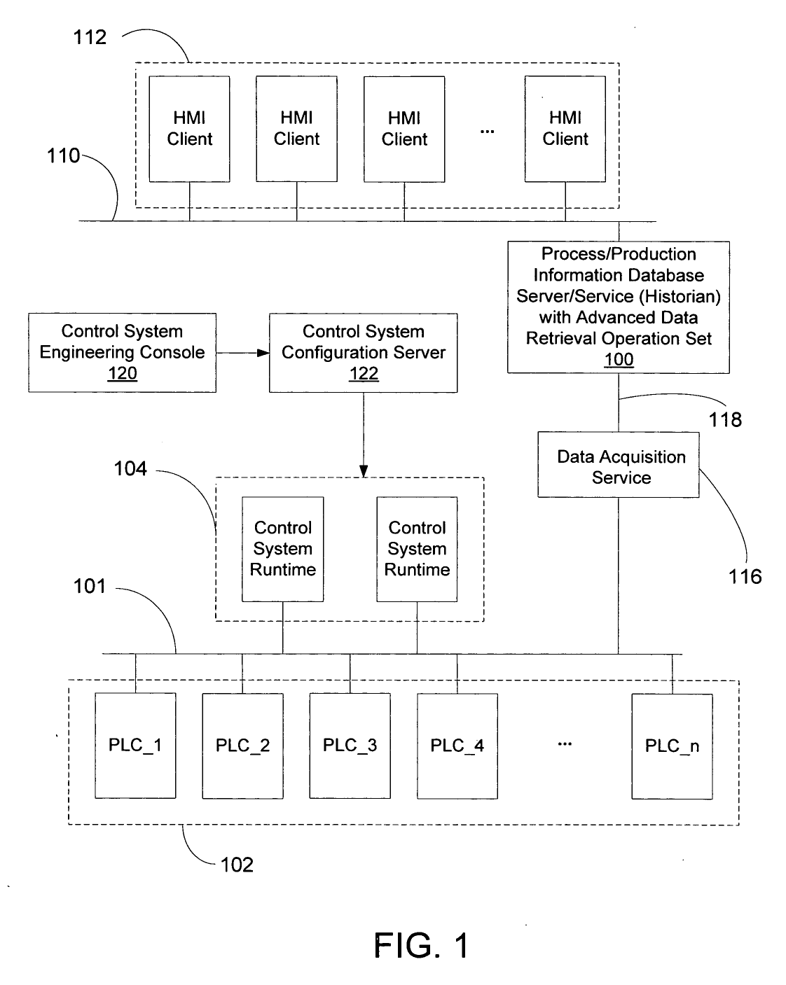

The following description is based on illustrative embodiments of the invention and should not be taken as limiting the invention with regard to alternative embodiments that are not explicitly described herein. Those skilled in the art will readily appreciate that the example of FIG. 1 represents a simplified configuration used for illustrative purposes. In many cases, the systems within which the present invention is incorporated are substantially larger. The volume of information handled by a historian in such a system would generally preclude pre-calculating and storing every type of information potentially needed by clients of the historian.

FIG. 1 depicts an illustrative environment wherein a supervisory process control and manufacturing/production information data storage facility (also referred to as a plant historian) 100 embodying the present invention is potentially incorporated. The network environment includes a plant floor network 101 to which a set of process control and manufacturing information data sources 102 are connected either directly or indirectly (via any of a variety of networked devices including concentrators, gateways, integrators, and interfaces). While FIG. 1 depicts the data sources 102 as programmable logic controllers (PLCs), the data sources 102 could also comprise any of a wide variety of devices including Input/Output (I/O) modules and distributed control systems (DCSs). The data sources 102 are coupled to, communicate with, and control a variety of devices such as plant floor equipment, sensors, and actuators. Alternatively, at least some of the data comes from a DCS. Data received from the data sources 102 may represent, for example, discrete data such as states, counters, and events and analog process data such as temperatures, tank levels and pressures, volume flow. In both cases, the data arise from a monitored control environment. A set of Control System Runtimes 104, such as WONDERWARE's DATA ACCESS SERVERS, acquire data from the data sources 102 via the plant floor network 101 on behalf of a variety of potential clients and subscribers including the historian 100.

The exemplary network environment includes a production network 110. In the illustrative embodiment the production network 110 comprises a set of human/machine interface (HMI) nodes 112 that execute plant floor visualization applications supported, for example, by Wonderware's INTOUCH visualization application management software. The data driving the visualization applications on the HMI nodes 112 are acquired, by way of example, from the plant historian 100 that also resides on the production network 110. The historian 100 includes services for maintaining and providing a variety of plant, process, and production information including historical plant status, configuration, event, and summary information.

A data acquisition service 116, for example WONDERWARE's REMOTE IDAS, interposed between interposed between the Control System Runtimes 104 and the plant historian 100, operates to maintain a continuous, up-to-date, flow of streaming plant data between the data sources 102 and the historian 100 for plant/production supervisors (both human and automated). The data acquisition service 116 acquires and integrates data (potentially in a variety of forms associated with various protocols) from a variety of sources into a plant information database, including time-stamped data entries, incorporated within the historian 100.

The physical connection between the data acquisition service 116 and the Control System Runtimes 104 can take any of a number of forms. For example, the data acquisition service 116 and the Control System Runtimes 104 can be distinct nodes on the same network (e.g., the plant floor network 101). However, in alternative embodiments the Control System Runtimes 104 communicate with the data acquisition service 116 via a network link that is separate and distinct from the plant floor network 101. In an illustrative example, the physical network links between the Control System Runtimes 104 and the data acquisition service 116 comprise local area network links (e.g., Ethernet) that are generally fast, reliable, and stable and thus do not typically constitute a data-stream bottleneck or source of intermittent network connectivity.

The connection between the data acquisition service 116 and the historian 100 can also take any of a variety of forms. In an embodiment of the present invention, the physical connection comprises an intermittent or slow connection 118 that is potentially too slow to handle a burst of data, unavailable, or faulty. The data acquisition service 116 therefore includes components and logic for handling the stream of data from components connected to the plant floor network 101. In view of the potential throughput and connectivity limitations of connection 118, to the extent secondary information is to be generated or provided to clients of the historian 100 (e.g., HMI nodes 112), such information should be rendered after the data have traversed the connection 118. In an embodiment, the secondary information is rendered by advanced data retrieval operations incorporated into the historian 100.

To change the configuration of this system, a user first enters the changes via a Control System Engineering Console 120. The changes are stored in the Control System Configuration Server 122 which may store configurations for multiple runtime environments. The configuration changes are deployed to the Control System Runtimes 104 during synchronization.

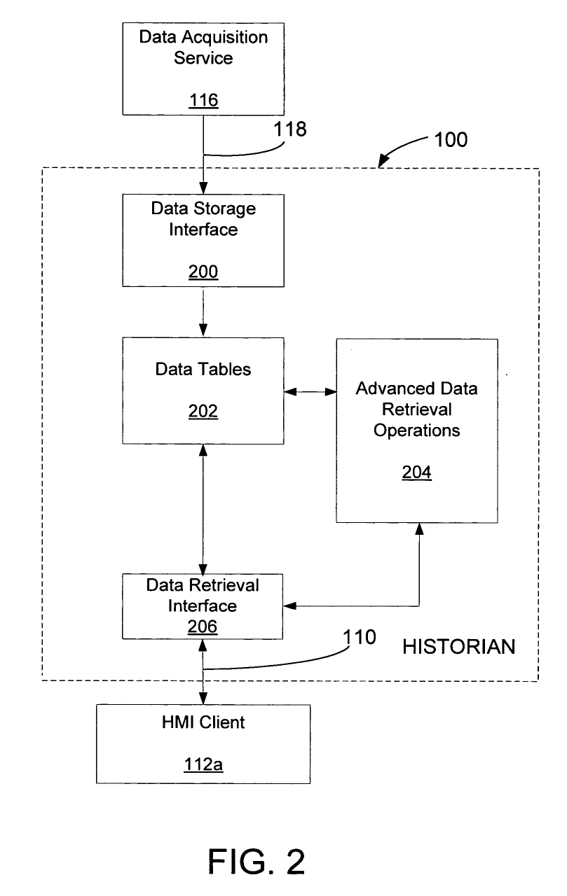

FIG. 2 depicts functional components associated with the historian 100. The historian 100 generally implements a storage interface 200 comprising a set of functions and operations for receiving and tabling data from the data acquisition service 116 via the connection 118. The received data are stored in one or more tables 202 maintained by the historian 100.

By way of example, the tables 202 include pieces of data received by the historian 100 via a data acquisition interface to a process control and production information network such as the data acquisition service 116 on network 101. In the illustrative embodiment each data piece is stored in the form of a value, a quality, and a timestamp. These three parts to each data piece stored in the tables 202 of the historian 100 are described briefly below.

Timestamp: The historian 100 tables data received from a variety of “real-time” data sources, including the Control System Runtimes 104 (via the data acquisition service 116). The historian 100 is also capable of accepting “old” data from sources such as text files. Traditionally, “real-time” data exclude data with timestamps outside of ±30 seconds of a current time of a clock maintained by a computer node hosting the historian 100. However, real-time data with a timestamp falling outside the 30-second window are addressable by a quality descriptor associated with the received data. Proper implementation of timestamps requires synchronization of the clocks utilized by the historian 100 and data sources.

Quality: The historian 100 supports two descriptors of data quality: “QualityDetail” and “Quality.” The QualityDetail descriptor is based primarily on the quality of the data presented by the data source, while the Quality descriptor is a simple indicator of “good,” “bad,” or “doubtful,” derived at retrieval time. Alternatively, the historian 100 supports an OPCQuality descriptor that is intended to be used as a sole data quality indicator that is fully compliant with OPC quality standards. In an alternative embodiment, the QualityDetail descriptor is utilized as an internal data quality indicator.

Value: A value part of a stored piece of data corresponds to a value of at received piece of data. In exceptional cases, the value obtained from a data source is translated into a NULL value at the highest retrieval layer to indicate a special event, such as a data source disconnection. This behavior is closely related to quality, and clients typically leverage knowledge of the rules governing the translation to indicate a lack of data, for example by showing a gap on a trend display.

The following is a brief description of the manner in which the historian 100 receives data from a real-time data source and stores the data as a timestamp, quality, and value combination in one or more of its tables 202. The historian 100 receives a data point for a particular tag (named data value) via the storage interface 200. The historian compares the timestamp on the received data to (1) a current time specified by a clock on the node that hosts the historian 100 and (2) a timestamp of a previous data point received for the tag. If the timestamp of the received data point is earlier than or equal to the current time on the historian node then:
If the timestamp on the received data point is later than the timestamp of the previous point received for the tag, the received point is tabled with the timestamp provided by the real-time data source.
If the time stamp on the received data point is earlier than the timestamp of the previous point received for the tag (i.e., the point is out of sequence), the received point is tabled with the timestamp of the previously tabled data point “plus 5 milliseconds.” A special QualityDetail value is stored with the received point to indicate that it is out of sequence. (The original quality received from the data source is stored in the “quality” descriptor field for the stored data point.)

On the other hand, if the timestamp of the point is later than the current time on the historian 100's node (i.e., the point is in the future), the point is tabled with a time stamp equal to the current time of the historian 100's node. Furthermore, a special value is assigned to the QualityDetail descriptor for the received and tabled point value to indicate that its specified time was in the future. (The original quality received from the data source is stored in the “quality” descriptor field for the stored data point.)

The historian 100 can be configured to provide the timestamp for received data identified by a particular tag. After proper designation, the historian 100 recognizes that the tag identified by a received data point belongs to a set of tags for which the historian 100 supplies a timestamp. Thereafter, the time stamp of the point is replaced by the current time of the historian 100's node. A special QualityDetail value is stored for the stored point to indicate that it was timestamped by the historian 100. The original quality received from the data source is stored in the “quality” descriptor field for the stored data point.

It is further noted that the historian 100 supports application of a rate deadband filter to reject new data points for a particular tag where a value associated with the received point has not changed sufficiently from a previously stored value for the tag.

Having described a data storage interface for the historian 100, attention is directed to retrieving the stored data from the tables 202 of the historian 100. Access, by clients of the historian 100, to the stored contents of the tables 202 is facilitated by a retrieval interface 206. The retrieval interface 206 exposes a set of functions, operations, and methods (including a set of advanced data retrieval operations 204), callable by clients on the network 110 (e.g., HMI clients 112), for querying the contents of the tables 202. The advanced data retrieval operations 204 generate secondary information, on demand, by post-processing data stored in the tables 202. In response to receiving a query message identifying one of the advanced data retrieval options carried out by the operations 204, the retrieval interface 206 invokes the identified one of the set of advanced data retrieval operations 204 supported by the historian 100.

This document addresses detailed functional requirements related to accessing historical data in InSQL based on the Archestra model-view namespace, and it includes the requirements related to including Traceablity objects in the hierarchy used to browse for InSQL data.

The InSQL solution revolves around the existing public/private namespace capability in InSQL, in which a user can create an arbitrary hierarchy of groups containing other groups and InSQL tags. This provides a convenient mechanism; for replicating the Archestra hierarchical namespace for historized object attributes on the InSQL node. This replication strategy is the basis of the solution described in the remainder of the document.

An implementation of this strategy includes a new set of Archestra objects known as the “Production Events Module” (PEM) and aimed at providing generic event tracking and genealogy capabilities to IAS. The PEM objects historize data to an SQL Server database hosted on the InSQL Server, to which the engine hosting the objects is historizing its process data. The PEM objects are included in the namespace described above even though they do not typically have historized attributes.

The detailed functional requirements for the Historian SDK are specified below.

Principles of Operation: The solution results in the InSQL tag configuration database being populated automatically with a public-group namespace that mirrors the Archestra model view for all historized object attributes, as well as all PEM objects and their parent objects. Specifically, “model view” here refers to the effective model-view hierarchy that exists in the system at runtime.

Whenever anything changes in the system that implies a modification to the model view for historized attributes, the changes are automatically propagated to the InSQL node within a reasonable amount of time. No user action is required to facilitate the synchronization between the galaxy repository and the InSQL node (other than enabling the feature, see below).

The bulk of the information required by InSQL for building up its namespace is sent as additional information (relative to what is being sent in current versions of IAS) by the historian primitive at tag-creation time. The detailed implementation may require other actions of sending information (such as the full area hierarchy) to InSQL at different times using different transport mechanisms. For purposes of the present discussion, however, the engine is deemed the agent responsible for transmitting all information to InSQL.

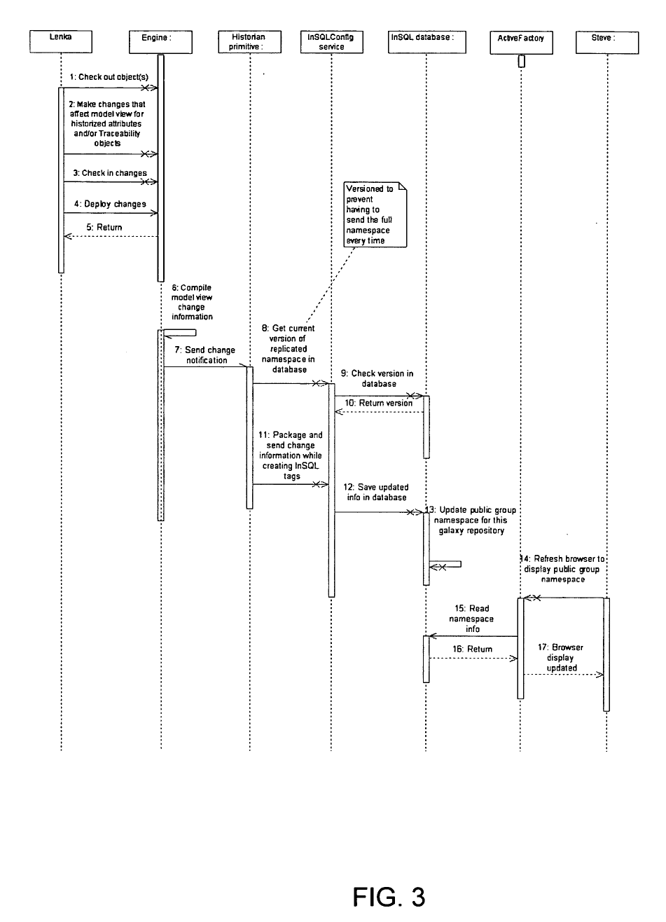

Please refer to the sequence diagram in FIG. 3. A typical sequence of events starts with changes being made to objects or to their attributes such that the model view is modified. For example, objects are added or deleted, historization settings are changed on one or more attribute, objects are moved to a different area, or PEM objects are added. Once the changes are made effective (by deploying the affected objects), the modifications are sent across to the InSQL node where the public-group namespace representing the particular galaxy repository is updated.

Data Format in InSQL Database: The model-view namespace in Archestra is replicated in the InSQL configuration database as a standard public-group namespace utilizing the public namespace schema provided in InSQL 8.0 and later. This ensures that existing clients, such as ActiveFactory, that are aware of the public/private-group namespace in InSQL can take advantage of the replicated model-view namespace in InSQL without modification.

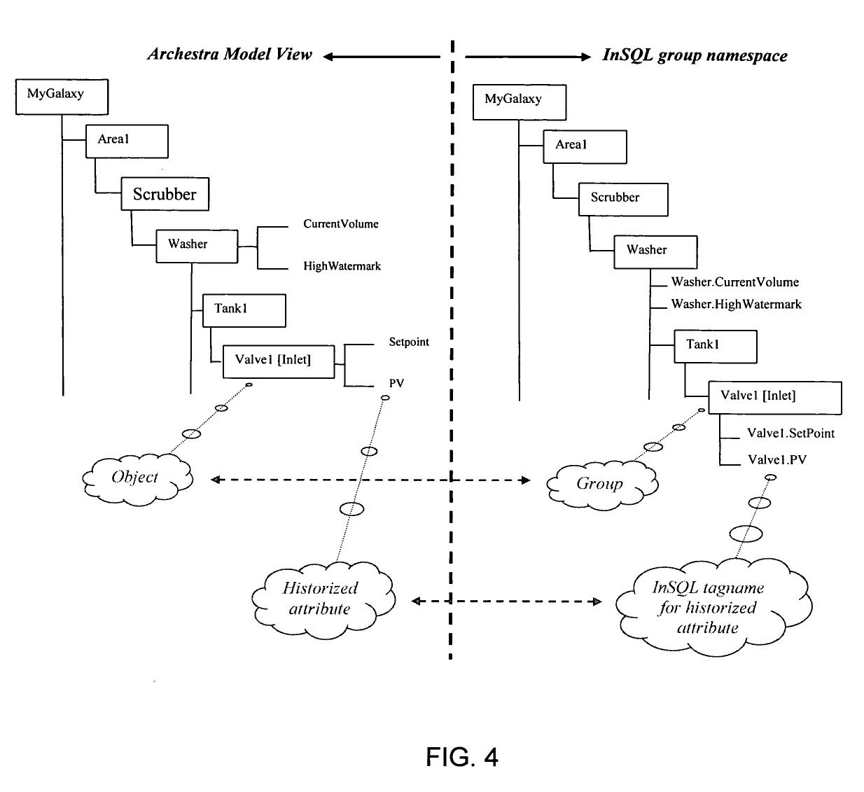

Data Format in InSQL Database, Structure: The replicated model-view namespace in the InSQL database is represented as a public-group namespace starting with a top-level group having the name of the galaxy. The top-level group contains a group for every child object and so on such that the object hierarchy is accurately reflected in the group and subgroup structure. Each group has the name of the object it represents. Each group contains, apart from its child groups, the InSQL tagnames representing the historized attributes of the group. Groups without any historized attributes are included in the namespace if they contain groups with historized attributes or if they contain PEM objects so as to preserve the full hierarchy of the model-view namespace. A sample Archestra model view and corresponding group namespace in InSQL are illustrated in FIG. 4.

Data Format in InSQL Database, Extent: The InSQL group namespace contains all historized attributes and their objects for the galaxy represented in that InSQL, plus any objects that contain objects with historized attributes, plus all PEM objects (and their parents, as needed to fill out the entire hierarchy). In other words, the complete hierarchy from galaxy level down to the lowest level object that has historized attributes is represented in the InSQL namespace, even if objects at intermediate levels do not have any historized attributes. Attributes that are not historized do not appear anywhere in the InSQL namespace.

Data Format in InSQL Database, Identification: The InSQL namespace is constructed so that it is possible for a client parsing the namespace to distinguish between regular objects and PEM objects.

Configuration: Provision is made, at configuration time and at runtime, to enable or to disable the automatic replication of the model view to the InSQL node associated with the galaxy. This enable and disable capability is provided in the IDE or SMC, i.e., the user controls the availability of this feature on the Archestra side at engine level. It is possible to control this behavior at runtime, i.e., without having to undeploy and redeploy the engine of any affected objects.

Manual Replication: The user has the ability to manually perform a replication by initiating an action in the Archestra SMC to dump the model-view information into one or more files in a location specified by the user and in a format suitable for manual transportation to the InSQL node. Once the user has manually copied the files to the InSQL node, a similar SMC action completes the replication into the InSQL public-group namespace.

Automatic Replication, Mechanism: Replication of the model-view namespace for objects with historized attributes in InSQL is in most cases triggered by events at runtime. The software implementing the replication uses a versioning scheme to detect the need for replication and to minimize the amount of information to be transmitted between the galaxy and the InSQL node. Therefore replication (sending information to InSQL and having it processed there) only takes place when the InSQL node public-group namespace is verified to be out of synchronization with the model view in terms of objects with historized attributes or PEM objects. Replication involves transmitting and processing only the information that needs to change in InSQL. For example, if one object is added to a galaxy of 1000 objects, then the new object is the only entity transmitted to InSQL and processed there to be incorporated into the public-group namespace. Once it has been verified that information has to be sent to InSQL to refresh its namespace, the actual transmission of information takes place when the historian primitive updates InSQL tag information. In other words, at the end of the normal tag-creation process, all the namespace information has been sent to InSQL.

Automatic Replication, Triggers: Replication of the Archestra model view for historized attributes to the InSQL group namespace happens automatically without any user interaction (unless otherwise noted) in response to any of the following triggers. In the following text, “replication” implies checking for the need to replicate as a first step. When InSQL starts up (cold start), InSQL initiates a replication with the IAS runtime. Whenever objects with historized attributes or PEM objects are deployed, the namespace is replicated to the extent required to maintain synchronization between the Archestra runtime and the InSQL namespaces. Whenever objects with historized attributes or PEM objects are undeployed, the InSQL namespace is updated to reflect the undeployed state for the affected objects. In other words, groups representing the objects in the InSQL namespace are not removed but assume a different state so that clients may display them differently.

Automatic Replication, Handling Replication Failures: If a replication is deemed necessary by the system and it fails to successfully complete (due, for example, to a network failure), then the system retries at periodic intervals until the replication succeeds. The retry interval does not exceed one minute.

Performance, Detection: The time to detect the need for a replication action, in response to a deploy action as specified above, does not exceed one minute from the time the deploy action completes.

Performance, Completing Replication: As stated above, namespace replication is largely integrated with the current mechanism in the historian primitive for creating InSQL tags. Based on this, the replication of the namespace to InSQL does not result in any increase in the time it takes to deploy an application of any size based on the current deployment performance in IAS 2.0.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details are determined by specific situations. Although the environment of the invention is described in terms of software modules or components, some processes may be equivalently performed by hardware components. Therefore, the invention as described herein contemplates all such embodiments as may come within the scope of the following claims and equivalents thereof.

We claim:

1. In a control environment, a method for synchronizing a software object in a first namespace with software objects in a second namespace, the method comprising:
detecting a change to the software object or to a historized attribute of the software object in the first namespace, wherein the change impacts the first namespace;
sending information about the detected change to the second namespace;
and
replicating the detected change in the second namespace.

2. The method of claim 1 wherein the first namespace is an Archestra namespace, and wherein the second namespace is an InSQL namespace.

3. The method of claim 1 wherein detecting a change comprises detecting a change selected from the group consisting of: a software object is added, a software object is deleted, a historization setting is changed on an attribute of a software object, a software object is moved, and a PEM object is added.

4. The method of claim 1 wherein sending information about the detected change comprises sending only as much information as necessary to characterize the change.

5. The method of claim 1 wherein sending information about the detected change comprises buffering the information and resending it, if necessary, until receipt of the information is acknowledged.

6. The method of claim 1 wherein replicating the change comprises replicating the change in a public-group namespace.

7. A computer-readable medium having computer-executable instructions for performing a method for synchronizing a software object in a first namespace with software objects in a second namespace, the method comprising:
detecting a change to the software object or to a historized attribute of the software object in the first namespace, wherein the change impacts the first namespace;
sending information about the detected change to the second namespace;
and
replicating the detected change in the second namespace.

8. The computer-readable medium of claim 7 wherein the first namespace is an Archestra namespace, and wherein the second namespace is an InSQL namespace.

9. The computer-readable medium of claim 7 wherein detecting a change comprises detecting a change selected from the group consisting of: a software object is added, a software object is deleted, a historization setting is changed on an attribute of a software object, a software object is moved, and a PEM object is added.

10. The computer-readable medium of claim 7 wherein sending information about the detected change comprises sending only as much information as necessary to characterize the change.

11. The computer-readable medium of claim 7 wherein sending information about the detected change comprises buffering the information and resending it, if necessary, until receipt of the information is acknowledged.

12. The computer-readable medium of claim 7 wherein replicating the change comprises replicating the change in a public-group namespace.
